(19) United States
(12) Patent Application Publication
(10) Pub. No.: US 2010/0280675 A1
(43) Pub. Date: Nov. 4, 2010

(54) METHOD FOR MANAGING ELECTRIC VEHICLE CHARGING LOADS ON A LOCAL ELECTRIC POWER INFRASTRUCTURE

(75) Inventors: Edward D. Tate, JR., Grand Blanc, MI (US); Peter J. Savagian, Bloomfield Hills, MI (US)

Correspondence Address: CICHOSZ & CICHOSZ, PLLC, 129 E. COMMERCE, MILFORD, MI, 48381, US

(73) Assignee: GM GLOBAL TECHNOLOGY OPERATIONS, INC., DETROIT, MI (US)

(21) Appl. No.: 12/766,968

(22) Filed: Apr. 26, 2010

Related U.S. Application Data
(60) Provisional application No. 61/174,130, filed on Apr. 30, 2009.

(51) Int. Cl. G06F 1/26

(52) U.S. Cl. 700/295; 320/109

(57) ABSTRACT

A method for managing electrical charging of an electrical energy storage device for a subject vehicle using electric power originating from a stationary source of electrical power includes providing a database including respective geographic locations of a plurality of electric power distribution subsystems, receiving a request from the subject vehicle for electric charging power, resolving a geographic location of the subject vehicle to a subset of the plurality of electric power distribution subsystems, determining an electric power reserve capacity for each electric power distribution subsystem in the subset of the plurality of electric power distribution subsystems, and allocating a magnitude of electric power for charging the subject vehicle based upon the electric power reserve capacity for each electric power distribution subsystem in the subset of the plurality of electric power distribution subsystems.

### CROSS-REFERENCE TO RELATED APPLICATIONS

This application claims the benefit of U.S. Provisional Application No. 61/174,130, filed Apr. 30, 2009, which is incorporated herein by reference.

### TECHNICAL FIELD

This disclosure is related to electric vehicle recharging.

### BACKGROUND

The statements in this section merely provide background information related to the present disclosure and may not constitute prior art.

Vehicles using electric power for propulsion include for example electric vehicles, range-extended electric vehicles, and plug-in hybrid electric vehicles. Electrically-powered vehicles are configured to reduce direct consumption of fossil fuels. Electrical energy storage devices for such vehicles may need to be periodically recharged. Such charging may be accomplished for example at the owner's residence. Charging at remote locations may be required.

Multiple vehicles simultaneously charging in a localized area may overload local electric power lines, transformers and systems. One method for preventing overload of the local electric power lines, transformers, and systems includes adding infrastructure, which increases capital costs and maintenance costs.

### SUMMARY

A method for managing electrical charging of an electrical energy storage device for a subject vehicle using electric power originating from a stationary source of electrical power includes providing a database including respective geographic locations of a plurality of electric power distribution subsystems, receiving a request from the subject vehicle for electric charging power, resolving a geographic location of the subject vehicle to a subset of the plurality of electric power distribution subsystems, determining an electric power reserve capacity for each electric power distribution subsystem in the subset of the plurality of electric power distribution subsystems, and allocating a magnitude of electric power for charging the subject vehicle based upon the electric power reserve capacity for each electric power distribution subsystem in the subset of the plurality of electric power distribution subsystems.

### BRIEF DESCRIPTION OF THE DRAWINGS

One or more embodiments will now be described, by way of example, with reference to the accompanying drawings, in which:

FIG. 1 is a schematic diagram of a charging management system for electrically charging a subject vehicle at a remote charging site using electric power originating from a stationary source of electrical power in accordance with the present disclosure;

FIG. 2 is a schematic drawing of a geographic area that includes a plurality of electric power distribution subsystems and associated charging stalls in accordance with the present disclosure; and

FIGS. 3 and 4 are flowcharts illustrating a method for allocating electric power flow to a subject vehicle within an electric power distribution subsystem in accordance with the present disclosure.

### DETAILED DESCRIPTION

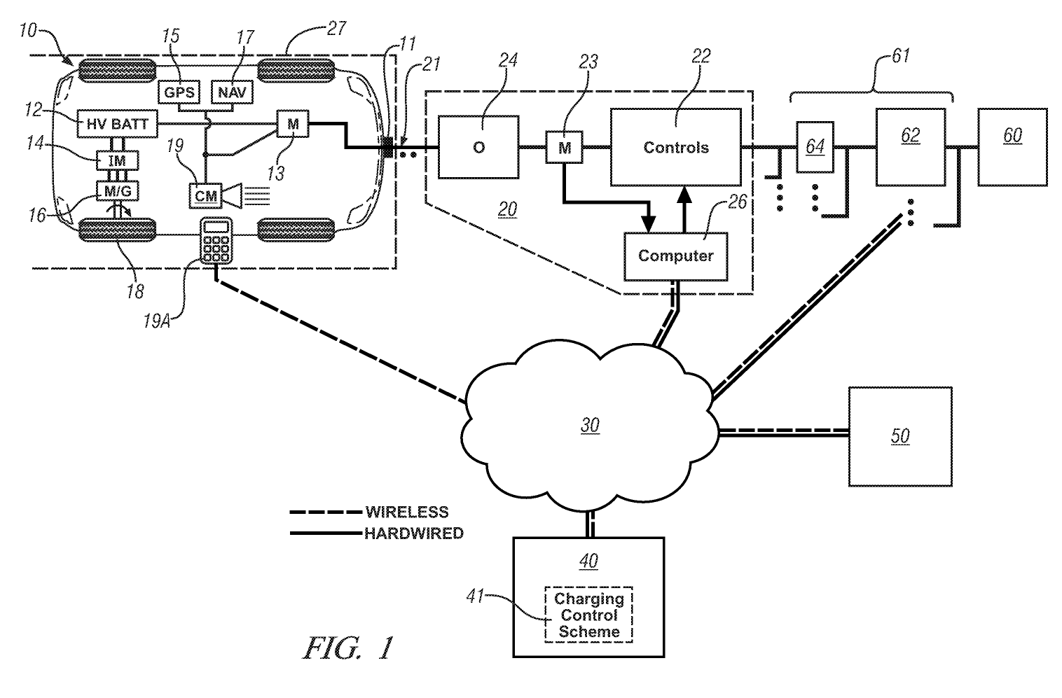

Referring now to the drawings, wherein the showings are for the purpose of illustrating certain exemplary embodiments only and not for the purpose of limiting the same, FIG. 1 schematically illustrates an electric power distribution system incorporating a charging management system for electrically charging electrically powered vehicles. Like numerals refer to like elements throughout the detailed description. The charging management system includes a charging control scheme 41 for remotely managing electrical charging of an individual subject vehicle 10 at a charging site 20 using electric power originating from a stationary source of electrical power, e.g., an electric power utility plant 60. The charging management system includes a remote access server 40 that executes the charging control scheme 41 using information obtained from a utility grid monitoring system 50 and a communications network system 30. Communications can be in the form of either or both wireless and hardwired communications.

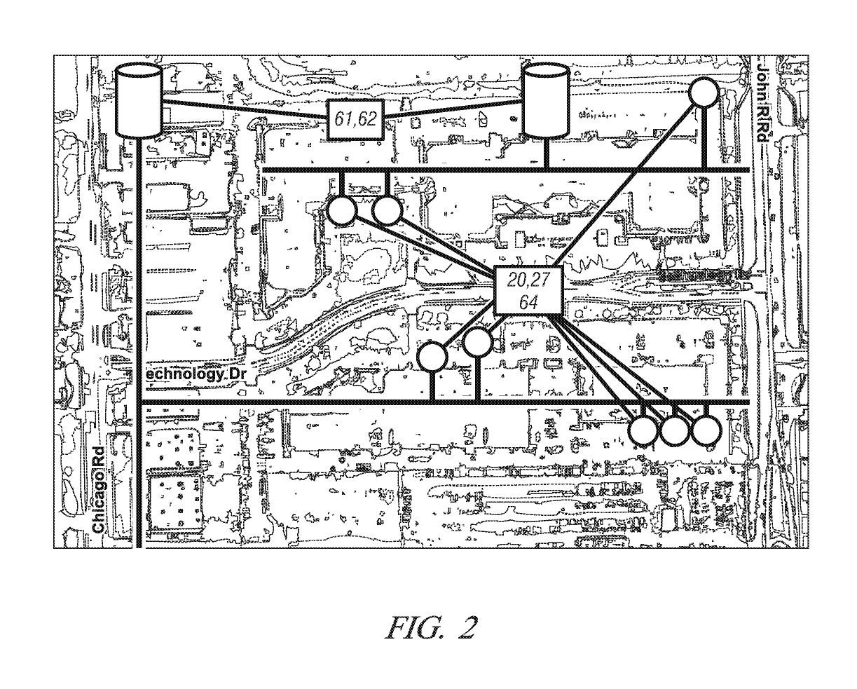

The electric power utility plant 60 is part of an electric power distribution system that transmits electric power via transmission lines to a plurality of local power networks, which are referred to herein as electric power distribution subsystems 61. Each electric power distribution subsystem 61 preferably includes a distribution substation 62 that steps down electric voltage before passing electric power through distribution lines to a plurality of distribution transformers 64, each of which electrically connects to one or a plurality of charging sites 20. It is appreciated that an electric power distribution system includes multiple transmission lines, multiple distribution substations 62, multiple distribution transformers 64, and multiple charging sites 20. An exemplary portion of an electric power distribution system is shown with reference to FIG. 2.

The subject vehicle 10 is an electrically powered vehicle that may be for example one of an electric vehicle, a range-extended electric vehicle, and a plug-in hybrid electric vehicle. The subject vehicle 10 preferably has a propulsion system that uses electric power supplied from an on-board electrical energy storage device, hereafter referred to as a high-voltage battery (HV Batt) 12. It is appreciated that the high-voltage battery 12 can include one or more multi-cell devices, ultracapacitors, or other electrical energy storage devices fabricated from materials that may include lithium-ion and other materials, with the scope of this disclosure not limited thereby. The propulsion system includes the high-voltage battery 12 electrically coupled to an electric motor/generator (M/G) 16 via an electric power inverter (I/M) 14. The electric motor/generator 16 converts electric energy to torque to provide propulsion power to one or more vehicle wheels 18. The high-voltage battery 12 electrically connects to an electrical charger connector 11 that electrically connects via cable 21 to an electric power outlet (O) 24 at each charging site 20 during a vehicle key-off period. An on-board electric power meter (M) 13 controls electric power flow and monitors and records cumulative electric power flow to the high-voltage battery 12, preferably in kilowatt-hours (kW-h). The high-voltage battery 12 is recharged using electric power supplied from the electric power utility 60 via the electrical power distribution subsystem 61 to which the charging site 20 is connected.

The subject vehicle 10 preferably includes a global positioning system (GPS) 15 which is useable to define a geographic location of the subject vehicle 10. The subject vehicle 10 may also include a navigation system (NAV) 17. The electric power meter 13 is configured to monitor and record cumulative electrical power flow (e.g., in kW-h) transferred to the high-voltage battery 12 through the electrical charger connection 11. The electric power meter 13 is preferably configured to capture and record a time and date of an electrical charging event, a geographic location of the subject vehicle 10 including a location and identifying elements related to the charging site 20, the owner of the charging site 20, and a magnitude of cumulative electric power flow (e.g., kW-h) transferred to the subject vehicle 10.

The subject vehicle 10 includes a control module (CM) 19 configured to monitor signal outputs from the electric power meter 13 and control electric power flow through the electric power meter 13. In one embodiment, the control module 19 has a wireless telematics communications system capable of extra-vehicle communications, including communication via the communications network system 30 having wireless and wired communications capabilities. The control module 19 communicates vehicle identification information to the remote access server 40 including the vehicle owner and/or account name, time and date, the approximate geographic location of the vehicle and a presence of electric power flow thereat. Vehicle identification information in the form of vehicle make, model, model year, VIN, color, and/or other parameters may also be communicated. Alternatively, the control module 19 has a wireless telematics communications system capable of short-range wireless communications to a handheld device 19A, e.g., a cell phone. In one embodiment the handheld device 19A is loaded with a software application that includes a wireless protocol to communicate with the control module 19, and the handheld device 19A executes the extra-vehicle communications, including communication to the remote access server 40 via the communications network system 30. In one embodiment, the vehicle information including the vehicle owner and/or account name, time and date, the approximate geographic location of the vehicle, presence of electric power flow thereat and vehicle identification information in the form of vehicle make, model, model year, VIN, color, and/or other parameters may originate from the control module 19, and be communicated to the communications network system 30 via the handheld device 19A. In one embodiment, a portion of the vehicle information including, e.g., the account name, time and date, and the approximate geographic location of the vehicle may originate from the handheld device 19A for communication via the communications network system 30 to the remote access server 40.

Each charging site 20 includes the electric power outlet 24 that electrically connects to a transformer 64 of one of the electric power distribution subsystems 61 preferably via a power access control device 22. The power access control device 22 may be employed at a commercial facility, a workplace, or another suitable location. Magnitude of cumulative electric power flow at the charging site 20 may be monitored using an electric power usage meter 23. A monitoring computer 26 controls the power access control device 22 to control magnitude of electric power flow through the electric power outlet 24. The monitoring computer 26 connects to the network system 30 via either or both wireless and wired communications schemes. It is appreciated that the charging site 20 can include any charging site, including those associated with the owner of the subject vehicle 10 and those owned and operated by another entity. It is appreciated that the charging site 20 may include a single one or a plurality of electric power outlets 24, with each electric power outlet 24 having an individual power access control device 22 and an electric power usage meter 23 that is individually controlled and monitored. The monitoring computer 26 communicates via the network system 30 to the remote access server 40 and the utility grid monitoring system 50 to transmit a magnitude of the cumulative electric power flow transferred to the subject vehicle 10. Each charging site 20 has a geographic location, i.e., longitude and latitude coordinates, and is registered in a Geographical Information Service (GIS) database that is accessible by the remote access server 40.

The utility grid monitoring system 50 includes monitoring devices and analytical tools that monitor and report on electric power flow in a portion of the electric power distribution system that includes at least one electric power utility plant 60, multiple transmission lines, multiple electric power distribution subsystems 61 including multiple distribution substations 62, multiple distribution transformers 64, and multiple charging sites 20. The utility grid monitoring system 50 monitors available supply of electric power and monitors electric power consumption in each electric power distribution subsystems 61. There can be a plurality of utility grid monitoring systems 50 associated with an electric power distribution system. In one embodiment described herein, the utility grid monitoring system 50 is configured to monitor each electric power distribution subsystem 61 that includes a single distribution substation 62 electrically connected through distribution lines to a plurality of distribution transformers 64, each which electrically connects to one or a plurality of charging sites 20. The utility grid monitoring system 50 continuously monitors states of parameters associated with operation of the electric power distribution subsystem 61, including frequency and amplitude of the transmitted electric power at various nodes.

The remote access server 40 preferably includes a computing system configured to provide data management functions associated with the electric power distribution system, including billing and account reconciliation, electrical charging management, geographic locations of charging sites 20 via the Geographical Information Service (GIS) database, and other functions. The charging control scheme 41 is preferably executed as a subsystem therein. The remote access server 40 communicates via the network system 30 with one or more monitoring computer(s) 26 to control the power access control device(s) 22 to manage electric power flow through the electric power outlet(s) 24 to electrically charge the subject vehicle(s) 10 parked at corresponding charging stall(s). Controlling the power access control device 22 includes locking and unlocking the power access control device 22 to prevent and permit electric power flow through the electrical power outlet 24 to the subject vehicle 10, and operating the power access control device 22 to control a magnitude of electric power flow therethrough to charge the subject vehicle 10. It is appreciated that other methods and devices can be employed to control magnitude of electric power flow from the electric power distribution subsystem 61 to charge the subject vehicle 10. It is appreciated that the remote access server 40 communicates via the network system 30 with other monitoring computers to control power access control devices to prevent and permit electric power flow through the electrical power outlet 24 to manage electrical charging of other electrically powered vehicles.

The charging management system includes subsystems for identifying a geographic location and an owner of the subject vehicle 10, resolving the geographic location of the subject vehicle 10, unlocking an electric power outlet 24, controlling a magnitude of electric power flow to the subject vehicle 10 while monitoring and recording a cumulative electric power flow, and communicating a magnitude of the cumulative electric power flow transferred to the subject vehicle 10 to a billing computer associated with the electric power utility 60, which can invoice, bill or otherwise collect payment from the owner of the subject vehicle 10 for the cumulative electric power flow to the subject vehicle 10.

The remote access server 40 queries the Geographical Information Service (GIS) database to resolve the location of the subject vehicle 10 using geographic location information from the subject vehicle 10. This can include resolving that the subject vehicle 10 is located at a specific charging stall at a specific charging site 20, resolving that the subject vehicle 10 is located in a geographic area coincident with a single identifiable electric power distribution subsystem 61, and resolving that the subject vehicle 10 is located in a geographic area coincident with a plurality of identifiable electric power distribution subsystems 61. As used herein, resolving the location of the subject vehicle 10 is intended to mean that there is sufficient information to come to a definite and firm conclusion about the location of the subject vehicle 10 relative to a specifically identifiable geographic location or area.

The electrical energy supplier credits an account of the owner of the charging site 20 for the electricity usage and bills an account of the vehicle owner for the electricity usage. The electrical energy supplier has a mechanism to adjust electrical energy bills to credit and debit individual accounts based on information provided by the vehicle.

The remote access server 40 communicates with the utility grid monitoring system 50 and with the plurality of vehicles parked at each of the plurality of charging stalls 27 and associated remote electrical outlets 24. The remote access server 40 can control the power access and electric power flow in the electric power distribution subsystem 61 to each of the plurality of remote electrical outlets 24.

FIG. 2 is a schematic drawing of a geographic area that includes a plurality of electric power distribution subsystems 61, and an associated plurality of charging stalls 20 having remote electrical outlets 24 that are mapped to network connections. Geographic locations, i.e., longitude and latitude coordinates of each of the charging stalls 27 and remote electrical outlets 24 are included in the aforementioned Geographical Information Service (GIS) database that is accessible to the remote access server 40. As shown, there are two electric power distribution subsystems 61, each preferably including a distribution substation 62 which steps down the electric voltage before passing electric power through distribution lines to a plurality of distribution transformers 64 which electrically connect to one or a plurality of charging sites 20. It is appreciated that the electric power distribution subsystem 61 may have other configurations. It is appreciated that the charging management system including the charging control scheme 41 executed as an element of the remote access server 40 takes into account that there can be a plurality of electrically powered vehicles that are simultaneously electrically charging across the electric power distribution subsystem 61.

The charging management system remotely manages vehicle charging via the wireless network. The remote access server 40 maintains a database of local power networks and geographical maps including approximate locations of a plurality of remote electrical outlets having network connections. Information from the GIS database is combined with the GPS data from the plurality of charging vehicles to estimate electrical power loading at the remote electrical outlets in an area. The remote access server 40 can also have feedback data on electrical loading of each electric power distribution subsystem 61. When charging, the subject vehicle first verifies via the wireless network that sufficient electric power capacity is available locally to manage the increased electrical load for an extended period of time. If insufficient capacity is available, the remote access server 40 allocates charging power among all vehicles on the local network, including the subject vehicle 10. Once charging, each of the vehicles continually queries the network to confirm the availability of charging power. The allocation of network power may be based for example on customer preferences, expected travel needs, cost sensitivity and aggregate power availability over a region. The allocation of network power can be accomplished by setting a constraint on power availability for each vehicle, or by setting a cost which is used by each vehicle to adjust its power draw based on internal tradeoffs of charging costs.

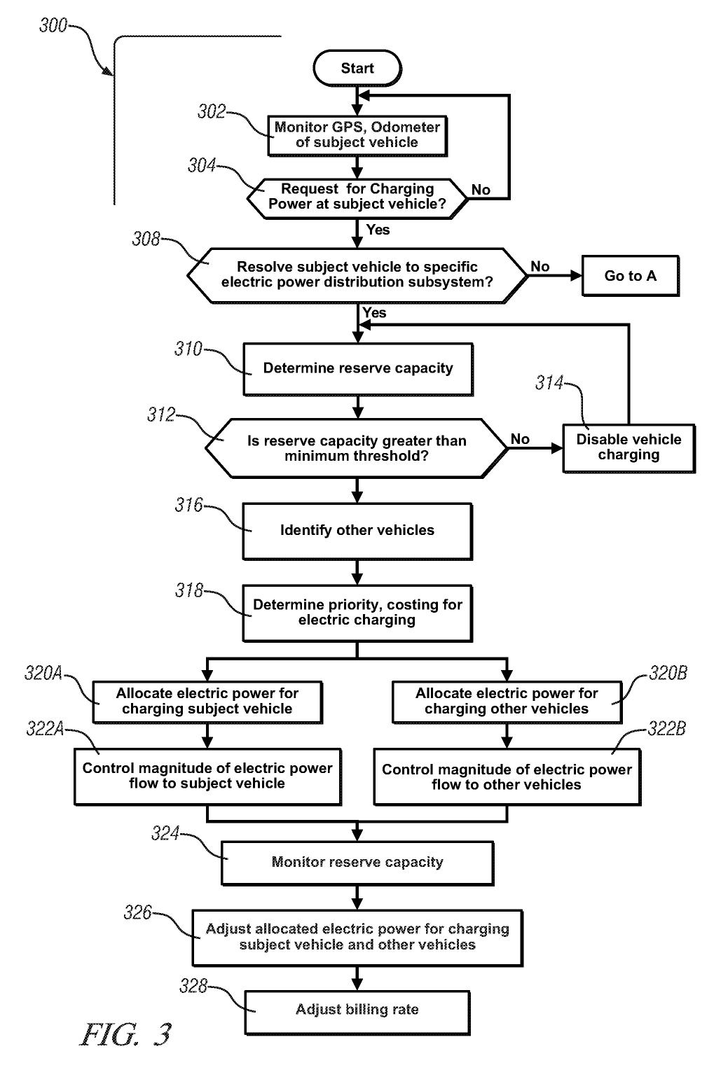

FIG. 3 shows an exemplary embodiment of a process 300 associated with the charging control scheme 41 for remotely managing electrical recharging of an on-vehicle electrical energy storage device for a subject vehicle 10, using the charging management system described with reference to FIG. 1. The remote access server 40 associated with the charging management system includes or has access to the GIS database of electric power distribution subsystem(s) 61 including geographical locations of a plurality of charging stalls 27 and a corresponding plurality of remote electrical outlets 24.

Information related to a geographic location originating from the subject vehicle 10 is ongoingly monitored, including output from the GPS 15, e.g., a last valid GPS reading, and distance traveled since the last valid GPS reading (302). The remote access server 40 monitors information from the subject vehicle 10 including a request for electric charging (304).

When the subject vehicle 10 has requested electric charging, indicating the subject vehicle 10 is stopped and keyed off, the remote access server 40 determines whether it is able to resolve a location of the subject vehicle 10 to a specific electric power distribution subsystem 61, and preferably to a specific charging stall 27 at a specific charging site 20 (308).

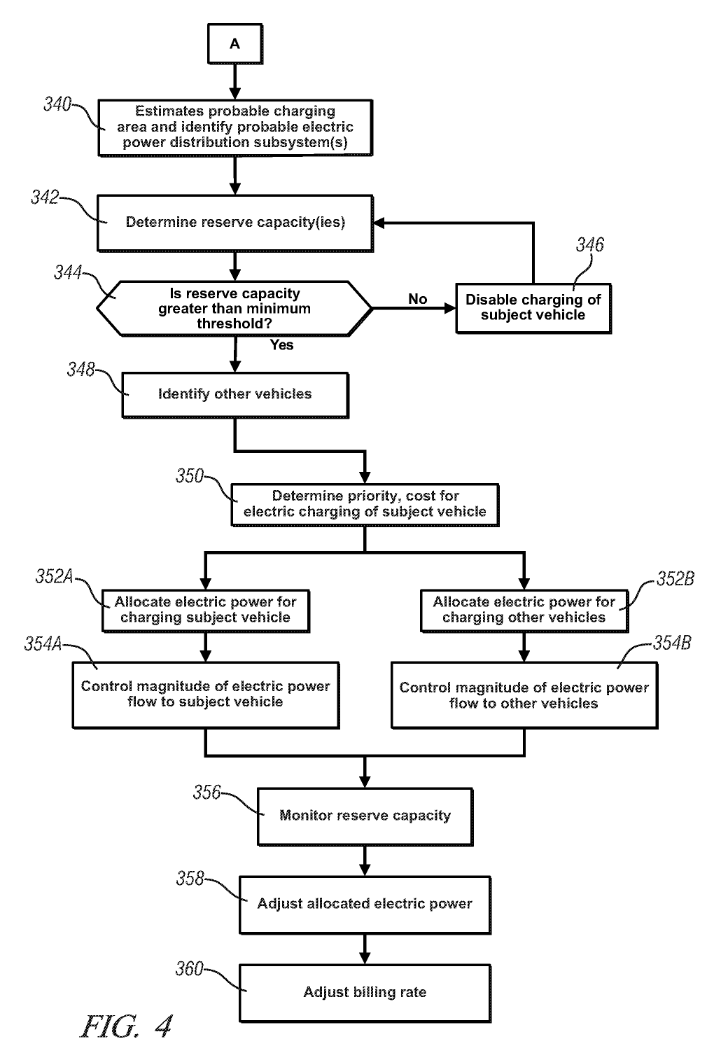

When the remote access server 40 is unable to resolve the location of the subject vehicle 10 to a specific electric power distribution subsystem 61 or specific charging stall 27 (Go to A), the remote access server 40 estimates a geographic location of the subject vehicle 10, described herein with reference to FIG. 4, to resolve the location of the subject vehicle to a subset of the plurality of electrical power distribution subsystems 61.

When the remote access server 40 is able to resolve the location of the subject vehicle 10 to a specific electric power distribution subsystem 61, it queries the grid utility monitoring system 50 to determine a maximum electric power reserve capacity for the electric power distribution subsystem 61 connected to the specific charging site 20 (310). The maximum electric power reserve capacity is analyzed to determine whether it is greater than a minimum threshold (312), thus verifying whether sufficient electric power capacity is available to manage an increased electrical load for an extended period of time associated with charging the subject vehicle 10. When there is insufficient electric power capacity available to manage an increased electrical load for an extended period, electrical charging of the subject vehicle 10 is disabled and the vehicle operator is notified (314). In one embodiment, electrical charging is disabled for the subject vehicle 10 and any other vehicles that are seeking to charge using the specific electric power distribution subsystem 61.

When there is sufficient electric power capacity available to manage an increased electrical load for an extended period, the other vehicles that are seeking to charge using the specific electric power distribution subsystem 61 are identified (316). Priorities and associated costs for electric charging of the subject vehicle 10 and the other vehicles are determined (318). The remote access server 40 allocates electric power and associated costs for charging the subject vehicle 10 (320A), and similarly allocates electric power and associated costs for charging the other vehicles (320B). Magnitudes of electric power flow to the subject vehicle 10 and the other vehicles are controlled based upon the allocated electric power (322A, 322B). This can include limiting or throttling the electric power flow to the subject vehicle 10 and/or the other vehicles based upon the allocated electric power and the charging priorities. During electrical charging operation, the reserve capacity of the specific electric power distribution subsystem 61 is ongoingly monitored (324), and the allocated electric power flows for the subject vehicle 10 and the other vehicles are adjusted in response to changes in the reserve capacity, including in response to other vehicle(s) connecting or disconnecting for electrical charging (326). Billing rates associated with the allocated electric power flows for the subject vehicle 10 and the other vehicles are similarly adjusted (328).

FIG. 4 shows continued operation of the process 300 associated with the charging control scheme 41 for remotely managing electrical recharging of an on-vehicle electrical energy storage device for the subject vehicle 10 when the remote access server 40 is unable to resolve the location of the subject vehicle 10 to a specific electric power distribution subsystem 61. The remote access server 40 estimates a geographic location of the subject vehicle 10 at a known resolution level associated with position and accuracy based upon communicated information from the subject vehicle 10 that includes the last valid GPS reading, the distance traveled since the last valid GPS reading, and the vehicle stop time indicating when the subject vehicle 10 is keyed off This can include information from the GPS 15 and optional navigation system 17. The remote access server 40 uses the GPS information and accuracy information to estimate a probable area for parking the subject vehicle 10 and related charging stall(s) 27. The probable area for electrical charging is compared to geographic information to identify an electric power distribution subsystem(s) 61 that may be requested to provide electric power for charging the subject vehicle 10. The remote access server 40 queries the GIS database to identify probable affected electric power distribution subsystem(s) 61, determine presence of other vehicles presently charging at associated charging stalls 27, and identify other constraints that may be used for setting charging constraints (340).

The remote access server 40 queries the grid utility monitoring system 50 to determine a maximum electric power reserve capacity for each electric power distribution subsystem(s) 61 in which the subject vehicle may be operating, which is saved as a constraint vector (342).

The remote access server 40 determines a minimum value for the constraint vector, i.e., a minimum of the maximum electric power reserve capacity(ies), and compares it with a minimum threshold (344). When the minimum value for the constraint vector is less than the minimum threshold, the remote access server 40 disables charging of the subject vehicle 10 (346). Otherwise, the remote access server 40 identifies the other vehicles seeking electrical charging in each of the electric power distribution subsystem(s) 61 (348), and determines a priority and a cost for electrical charging for the subject vehicle 10 (350). Electric power is allocated for charging the subject vehicle 10 (352A), and for charging the other vehicles (352B). Magnitude of electric power flow to the subject vehicle 10 is controlled based upon the allocated electric power and associated costs (354A), preferably by controlling the on-board electric power meter 13. Magnitudes of electric power flow to the other vehicles are controlled based upon the allocated electric power and associated costs (354B). Reserve capacity(ies) of the probable electric power distribution subsystem(s) 61 is monitored (356), and the allocated electric power flow is adjusted in response thereto (358). Similarly, a billing rate associated with the allocated electric power flow is adjusted for the subject vehicle 10, with accounts reconciled at the end of the charging period (360).

Thus, when multiple vehicles are present in the same area, the charging constraints are allocated to each of the vehicles either through a central allocation or via a distributed allocation scheme among the vehicles. In this way, available electrical power can be distributed and allocated. The remote access server 40 communicates with all the vehicles charging in a local power network and allocates charging power to each of the vehicles. As vehicles connect and disconnect from the network or other conditions change, the remote access server 40 may reallocate local charging power.

Thus, electrical power loading from a plurality of charging vehicles electrically connected to the remote electrical outlets in the area can be estimated. The subject vehicle communicates with the remote access server 40 to verify that sufficient electric power capacity is available locally to manage an increased electrical load for an extended period of time associated with charging the subject vehicle. The remote access server 40 allocates charging power among the plurality of charging vehicles electrically connected to the remote electrical outlets in the area. The system allows an operator of a plug-in hybrid vehicle, an extended range electric vehicle or an electric vehicle to recharge anywhere with the billing for the electricity properly reconciled. A commercial location can include hardware to automatically unlock the remote electrical outlet and enable charging.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method for managing electrical charging of an electrical energy storage device for a subject vehicle using electric power originating from a stationary source of electrical power, the method comprising:
providing a database including respective geographic locations of a plurality of electric power distribution subsystems;
receiving a request from the subject vehicle for electric charging power;
resolving a geographic location of the subject vehicle to a subset of the plurality of electric power distribution subsystems;
determining an electric power reserve capacity for each electric power distribution subsystem in the subset of the plurality of electric power distribution subsystems; and
allocating a magnitude of electric power for charging the subject vehicle based upon the electric power reserve capacity for each electric power distribution subsystem in the subset of the plurality of electric power distribution subsystems.

2. The method of claim 1, wherein determining the electric power reserve capacity for each electric power distribution subsystem in the subset of the plurality of electric power distribution subsystems comprises monitoring an available supply of electric power and monitoring electric power consumption in each electric power distribution subsystem in the subset of the plurality of electric power distribution subsystems.

3. The method of claim 1, wherein allocating the magnitude of electric power for charging the subject vehicle based upon the electric power reserve capacity for each electric power distribution subsystem in the subset of the plurality of electric power distribution subsystems comprises disabling charging the subject vehicle when the electric power reserve capacity in any one of the electric power distribution subsystems in the subset of electric power distribution subsystems is less than a predetermined threshold.

4. The method of claim 1, further comprising controlling electric power flow to the subject vehicle corresponding to the allocated magnitude of electric power.

5. The method of claim 4, further comprising operating the subject vehicle to control the electric power flow thereto corresponding to the allocated magnitude of electric power.

6. The method of claim 1, wherein allocating the magnitude of electric power for charging the subject vehicle based upon the electric power reserve capacity for each electric power distribution subsystem in the subset of the plurality of electric power distribution subsystems comprises:
identifying other vehicles charging from the subset of the plurality of electric power distribution subsystems; and
allocating magnitudes of electric power for charging the subject vehicle and charging the other vehicles based upon the electric power reserve capacity for each electric power distribution subsystem in the subset of the plurality of electric power distribution subsystems.

7. A method for managing electrical charging of an electrical energy storage device for a subject vehicle using electric power originating from a stationary source of electrical power, the method comprising:
providing a database including respective geographic locations of each of a plurality of charging stalls, each of the plurality of charging stalls corresponding to one of a plurality of electric power distribution subsystems;
receiving a request for electric charging power from the subject vehicle;
resolving a geographic location of the subject vehicle to one of the plurality of electric power distribution subsystems;
determining an electric power reserve capacity for the one of the plurality of electric power distribution subsystems; and
allocating a magnitude of electric power for charging the subject vehicle based upon the electric power reserve capacity for the one of the plurality of electric power distribution subsystems.

8. The method of claim 7, wherein allocating a magnitude of electric power for charging the subject vehicle based upon the electric power reserve capacity for the one of the electric power distribution subsystems further comprises:
identifying other charging vehicles for the one of the electric power distribution subsystems; and
allocating magnitudes of electric power for charging the subject vehicle and the other charging vehicles based upon the electric power reserve capacity for the one of the electric power distribution subsystems.

9. The method of claim 7, wherein resolving the geographic location of the subject vehicle to one of the plurality of electric power distribution subsystems comprises resolving the geographic location of the subject vehicle to one of the plurality of charging stalls.
